(19) United States
(12) Patent Application Publication
(10) Pub. No.: US 2021/0362225 A1
(43) Pub. Date: Nov. 25, 2021

(54) 5-AXIS THREE-DIMENSIONAL MANUFACTURING

(71) Applicant: 3D FLEXIBLE, INC., College Park, MD (US)

(72) Inventors: Victor E. YUN, College Park, MD (US); Yongzhang LENG, College Park, MD (US); Donghun PARK, College Park, MD (US)

(21) Appl. No.: 16/977,467

(22) PCT Filed: May 20, 2019
(86) PCT No.: PCT/US2019/033189

§ 371 Date: Sep. 1, 2020

Related U.S. Application Data
(63) Continuation of application No. 16/016,651, filed on Jun. 24, 2018, now abandoned.
(60) Provisional application No. 62/674,017, filed on May 20, 2018.

(51) Int. Cl. B22F 1/00; B33Y 70/00; B33Y 10/00; B22F 10/10

(52) U.S. Cl. CPC B22F 1/0074; B22F 1/0011; B33Y 70/00; B22F 9/082; B22F 10/10; B22F 2301/35; B33Y 10/00

(57) ABSTRACT

A multiple axis manufacturing platform for three-dimensional object fabrication in three dimensions and along at least two rotary axes. The platform includes one or more additive and one or more subtractive manufacturing tools. An automatic tool changer (ATS) holds the additive and the subtractive manufacturing tools and selects among them. A movable substrate platform supports a workpiece. A programmable control system has one or more programs for controlling the manufacturing tools, the automatic tool changer and the movable substrate platform, and includes machine code to control one or more relay switches to control the additive manufacturing tools. A machine vision system detects displacement between or features of deposited material. A vision camera mounting for the spindle housing allows viewing the manufacturing process. A laser displacement sensor extracts distance and position of the selected tool or the workpiece. A feedback system is used to dynamically control material flow from an additive manufacturing tool.

### FIELD OF THE INVENTION

The present invention relates to hybrid 5-axis manufacturing of three-dimensional objects using a variety of material deposition and material removal tools that operate in three dimensions and along two rotary axes, and may equally be applied to 6-axis or multiple-axis platforms. The present invention further relates to materials used in additive manufacturing of three-dimensional objects.

### BACKGROUND

5-axis manufacturing allows machine tools to approach a workpiece from all directions, typically without the need to reposition the workpiece, providing flexibility in terms of material deposition and material removal. As seen in FIG. 12, the 5-axes are the X, Y, Z axes along with rotation about the X-axis (“A”) and rotation about the Y axis (“B”). Alternatively, there may be rotation about the Z-axis (“C”) and machines may provide a variety of combinations of the rotational capabilities.

5-axis manufacturing can be applied to perform additive fabrication such as three-dimensional printing of polymers, metals, and ceramics, enabling the manufacturing of flexible electronics. In additive manufacturing, a product is built up, layer by layer, such that various compositions and structures can be customized. 5-axis manufacturing can drastically change conventional manufacturing processes and products in various areas such as defense, security, the Internet-of-things, and custom-designed machine parts. Manufacturing in high volume production requires the capability of making multilayer and/or multifunctional structures with a computer-controlled seamless process.

For additive manufacturing, aerosol jet printing may be used to deposit a variety of materials including metals, dielectrics, and polymers. In aerosol jet printing, droplets are precisely focused on an area of deposition. Typically, a transducer operates on a reservoir of material that is atomized and carried by a carrier gas to a nozzle. Sheath gases focus the aerosolized material, creating a stream of material flow of precision diameter for deposition on a substrate

Integration of aerosol jet printing in a 5-axis system permits the formation of a variety of complex article shapes and compositions,

Although 5-axis manufacturing has been applied to make a variety of products, there are areas requiring improvement in order to apply 5-axis manufacturing to make various precision products. In order to integrate additive manufacturing and subtractive manufacturing to make a product, rapid and precise tool changing is needed. Further, for computer-controlled manufacturing, precision tool positioning from a workpiece is needed along with precision stage alignment. There additionally needs to be better computer control of machine tools for additive manufacturing, such as material deposition from a nozzle. Finally, improved materials for deposition by additive manufacturing are also needed. The present disclosure addresses all of these areas of concern.

### SUMMARY OF THE INVENTION

The present invention provides a 5-axis manufacturing platform for three-dimensional object fabrication operating in three dimensions and along two rotary axes, and may equally be applied to 6-axis or multiple-axis platforms. The platform may be produced by modifying commercially-available equipment when a control system includes software capable of modification to control additive manufacturing tools. The platform includes one or more additive manufacturing tools and one or more subtractive manufacturing tools. An assembly allows a spindle originally designed for subtractive manufacturing tools to engage one of the additive manufacturing tool. An automatic tool changer holds both the additive manufacturing tools and the subtractive manufacturing tools and selects among the additive manufacturing tools and the subtractive manufacturing tools and positions a selected tool on the spindle. A movable substrate platform supports a workpiece for additive or subtractive manufacturing by the selected tool

A programmable control system has one or more programs for controlling the one or more additive manufacturing tools, the one or more subtractive manufacturing tools, the automatic tool changer and the movable substrate platform, wherein the program includes machine code to control one or more relay switches to control the additive manufacturing tools. A machine vision system detects displacement between the selected tool and the workpiece or for detecting features of deposited material on the workpiece. A laser displacement sensor extracts distance and position of the selected tool or the workpiece. A feedback system cooperates with one or more of the movable substrate platform, the programmable control system, or the machine vision system to dynamically control material flow from an additive manufacturing tool.

### BRIEF DESCRIPTION OF THE DRAWINGS

FIG. 1 depicts a manufacturing platform according to an embodiment;

FIG. 2 depicts an automatic tool changer for use in the embodiment of FIG. 1.

FIG. 3A, 3B, and 3C depict an automatic tool changer for use in the embodiment of FIG. 1.

FIGS. 4A and 4B show a disengaged and engaged printing tool for use in the embodiment of FIG. 1.

FIG. 5 depicts laser displacement adjustment for use in the embodiment of FIG. 1.

FIGS. 6A and 6B depict dispensed material from the embodiment of FIG. 1; FIG. 6C depicts a modified manufacturing system to deposit material.

FIG. 7 depicts a kinematic/gimbal mirror mount for use in the embodiment of FIG. 1.

FIG. 8 depicts and X-Y coordinate system offset.

FIG. 9 depicts an X-Y-rotation coordinate offset.

FIG. 10 depicts a three-axis coordinate offset.

FIG. 11 depicts a 5-axis coordinate offset.

FIG. 12 depicts a four-axis motion stage coordinate system.

FIG. 13 depicts a sequence for creating G-code for additive manufacturing.

FIGS. 14A-14B depict workpiece pallet systems transferring among manufacturing and scanning apparatus.

FIG. 15 depicts fiducial points for the manufacturing platform of FIG. 1.

FIG. 16 depicts a machine vision system.

FIG. 17A-FIG. 17B depict rotation of a machine vision system,

FIG. 18 depicts the relation of a machine vision system to other parts of the manufacturing platform.

FIG. 19 schematically depicts the structure of an unsintered and sintered metal paste according to an embodiment;

FIG. 20A-FIG. 20D schematically depict an apparatus including a nozzle for depositing the metal paste of FIG. 19;

FIGS. 21A and 21B depict inner and outer wall deposition for later backfilling using the metal pastes of the present invention;

FIGS. 22A-22D depict fabrication of a metal dome using the metal pastes of the present invention; FIGS. 22E-22F depict fabrication of various curved shapes by additive manufacturing;

FIGS. 23A-23D depict toolpaths for fabricating a variety of shapes by additive manufacturing with metal pastes;

FIGS. 24A-24C depict fabrication of a metal box using the metal paste of the present invention.

### DETAILED DESCRIPTION

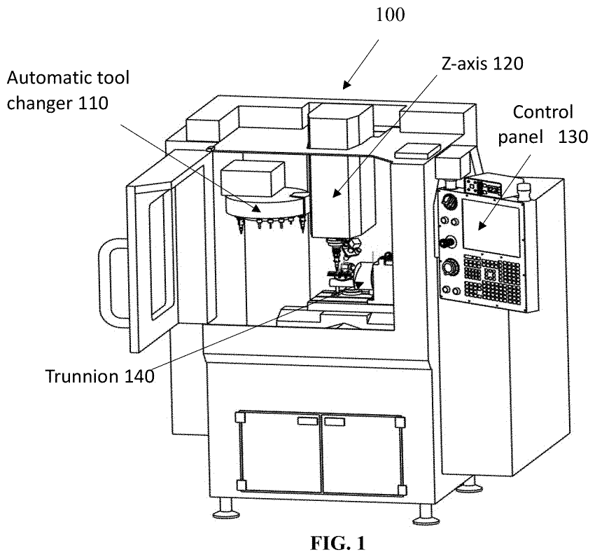

A modified computerized numerical control (CNC) mill 100 as shown in FIG. 1 can be applied for versatile 3D manufacturing platforms to be able to perform multifunctional 3D printing tasks on a single platform without depending on different printing platforms; For example, a commercially available, industry standard Haas CNC-mill, designed for only subtractive manufacturing, can be modified for hybrid additive and subtractive manufacturing. The hardware and software modifications to CNC mills, combined with highly-developed CAD/CAM of a user's choice, convert a conventional subtractive machine tool, into a versatile combination additive manufacturing and subtractive manufacturing platform. The inventive manufacturing platform can be controlled for printing by user-defined G/M-code from CAD/CAM software. By doing this, users can avoid displacement error caused by moving objects into a different printing platform and achieve a small size, weight, power and cost (SWaP-C) printing solution. As seen in FIG. 1, the manufacturing platform includes an automatic tool changer 110, a Z-axis stage 120, trunnion 140, and a control panel 130. The automatic tool changer permits changing between additive manufacturing tools such as 3D printing syringes, and subtractive tools such as milling tools and laser machining tools. The control panel permits interactive programming, including machine language programming, to be discussed in further detail below.

In another aspect, the present invention provides hardware and software modifications to convert CNC mills combined with highly developed CAD/CAM of the user choice into a versatile combination/hybrid additive manufacturing and subtractive manufacturing platform. Additive tools perform printing, dispensing, jetting, while subtractive and other tools perform pick-and-place of components, laser drilling, laser cutting, and alignment, are attached to assemblies with ISO standard CNC tapers to accommodate incorporation in an automatic tool changer.

In order to accommodate the additive manufacturing capability to a standard CNC mill, additional assemblies are provided for the tools pressure, electrical, and vacuum connections which, combined with post-processing software, allow completion of a manufacturing process without additional manual operator input during a manufacturing process that combines additive, subtractive, and other processes into a single manufacturing platform.

Automatic Tool Changing

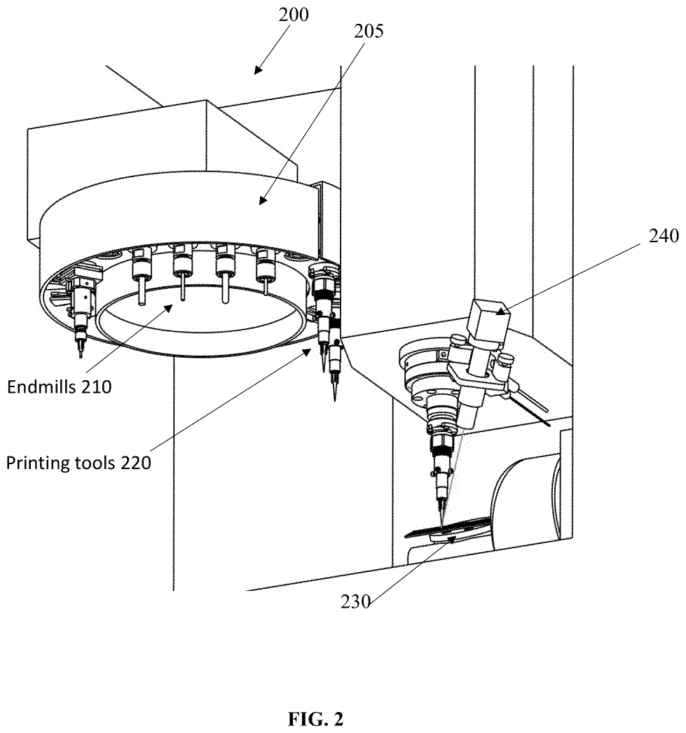

A variety of tools are used in additive manufacturing for material deposition. In the present invention, subtractive manufacturing tools for material removal are integrated into the same, single platform manufacturing system. An automatic tool changer (ATC) 200 as shown in FIG. 2 is used in computerized numerical control (CNC) machines to improve the production and tool carrying capacity of the machine. ATC changes the tool very quickly, reducing the non-productive time. As seen in FIG. 2, a variety of material cutting and shaping tools are mounted in the carousel 205 and can be changed to perform pre-programmed sequences such as drilling, milling, counter-boring, etc. In addition, a variety of additive manufacturing tools can be added. End mills 210 are depicted as examples of milling tools while syringes 220 are depicted as examples of printing deposition tools. A substrate-holding stage 230 is programmably movable so that a variety of complex positions may be achieved. A single camera machine vision system 240, to be discussed in further detail below, can be incorporated into the manufacturing platform to provide positioning feedback, e.g., for deposition syringes when new syringes are positioned, or deposition feedback, e.g., for monitoring the shape of a deposited feature and altering deposition parameters.

However, additive manufacturing involves additional tools such as nozzles 220 that eject various materials for deposition on a substrate. Nozzles are also included for pick and place of components on a substrate. Accordingly, the present invention performs many pre-programmed functions to manufacture sensors and devices. Unlike conventional cutting tools, many additive manufacturing tools require high pressure compressed air, vacuum and 12V voltage connections and the connectors needed to engage and disengage automatically without the user's input. As seen in the drawings, the additive tools such nozzles include ISO-standard CNC tapers that allow them to be accommodated in the automatic tool changers.

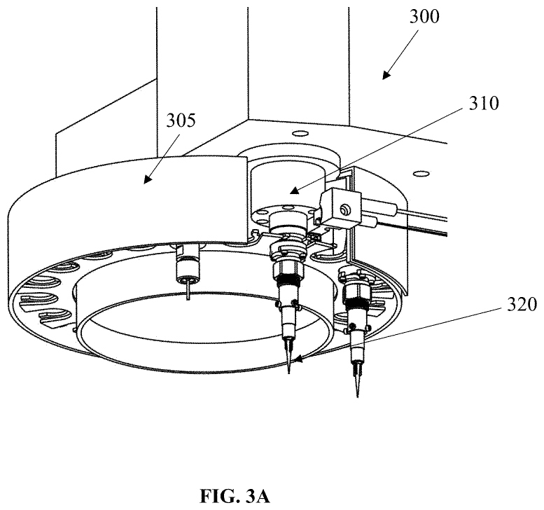

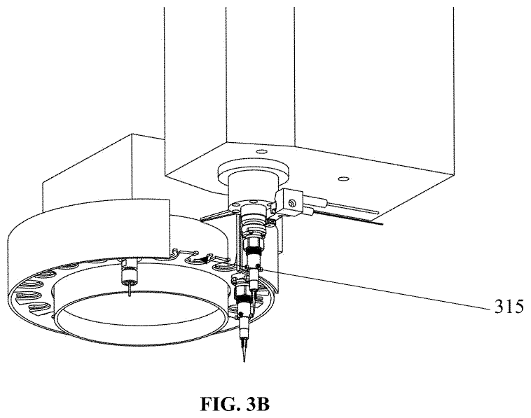

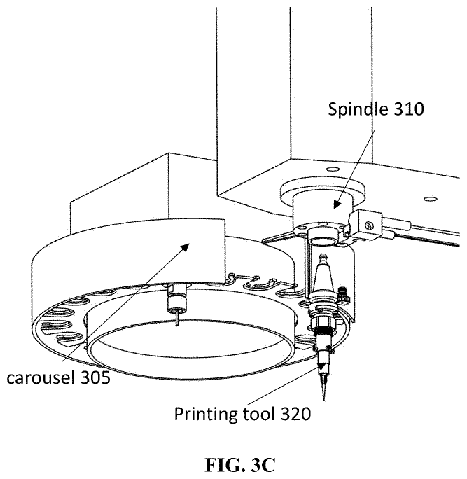

FIG. 3A depicts an automatic tool changer 300 with a carousel 305 and spindle 310 engaging a syringe 320 while FIG. 3B depicts the automatic tool changer with the spindle disengaged from the carousel. Element 315 indicates the holder for the syringe/printing tool in the carousel. FIG. 3C illustrates a printing tool 320 disengaged from the spindle 310. Tools may he assigned tool numbers, with each individual tool's information stored in toolpath generation software.

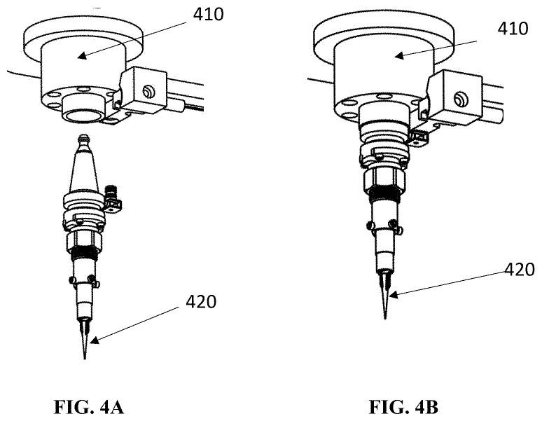

FIG. 4A shows a disengaged dispensing tip printing tool 420 and FIG. 4B shows an engaged dispensing tip printing tool 420 positioned on a 5-axis machine tool spindle 410.

These dispensing tips will be automatically changed in accordance with the programming by the automatic tool changer 300 of the present invention. The tool changer in the CNC-mill for multiple printing heads includes, but is not limited to syringe, inkjet, and aerosol printing heads. A seamless multifunctional printing process is controlled by G/M-code using Factory Interface Language (FIL). The type of tools in the inventive automatic tool changer include multifunctional heads that can deposit dielectric materials or conductive pastes, pick-n-place systems, laser displacement sensors, UV LED or laser, and optical coordinate measuring machines. The present invention optimizes programming flexibility and decreases operator induced errors by changing additive manufacturing tools automatically decreases total production time while freeing the operator from in-between operations, which might include platform changes.

Laser Displacement Adjustment

In additive manufacturing, the distance between the material output point, such as the tip of a syringe or nozzle, and the product surface is critical for uniform and consistent product production. Distal error caused by alignment and/or imperfect 3D models may cause severe malfunction in 3D printed electronic circuits. The present invention describes distance adjustment techniques for improving alignment between the material output point and the surface. In-situ distal sensing is used for linear motion control of a nozzle or syringe head. Software generates a modified G-code based on the result from pre-scanning. The distal sensor detects the actual distance and modifies the G-code based on the actual distance vs. the calculated distance from the model. Thus, the final printing is based on the actual distance detected by the sensor. FIG. 5 shows a diagram of laser displacement adjustment. The laser distance sensor 510 measures the distance between the surface and laser (or reference position). The object can be modelled in CAD/CAM software 520, but the real object 530 may not be the same as the initial model to an accuracy required for printing. The distal sensor 510 can move along with a generated tool path, measure, and save the distance into a file. A software uses the distance information to generate a new G-code for more accurate printing by modification of the existing G-code that was generated based on the CAD/CAM model.

In additive manufacturing, the distance between the material output point, such as the tip of a syringe or nozzle, and the product surface is critical for uniform and consistent product production. Distal error caused by alignment and/or imperfect 3D models may cause severe malfunction in 3D printed electronic circuits. The present invention describes distance adjustment techniques for improving alignment between the material output point and the surface. In-situ distal sensing is used for linear motion control of a nozzle or syringe head. Software generates a modified G-code based on the result from pre-scanning, as shown in FIG. 5. The distal sensor, for example, laser sensor 510 detects the actual distance and modifies the G-code based on the actual distance 530 vs. the calculated distance 520 from the model. Thus, the final printing is based on the actual distance 530 detected by the sensor 510. A laser sensor 510 may be incorporated in the manufacturing system of FIGS. 3A-3C.

Dispensing Tip Alignment

With the advanced features of additive manufacturing with multiple materials (dielectric, conductive, and metallic), there is a need for automatic replacement of the material dispensers such as pneumatic syringes and tips. Further, whenever disposable tips are changed due to clogging or damage, axial alignment is required due to the small manufacturing differences (defects) of standard syringe tips. The re-positioning accuracy of syringe tips determines the minimum feature sizes and alignment of multi-layer fabrication. The small offset in the z-axis (vertical) can be compensated with the machine tool's spindle height before the dispensing process starts. This is a one-time adjustment for a replacement of dispensing material or tip. However, the x-axis and y-axis offsets from the replacement cannot be compensated for with the re-adjustment of the machine tool platform's x and y axes because layers of materials have already been dispensed. Platform coordinate adjustments would introduce offsets among structure layers and materials.

Typical X and Y axis adjustments are implemented using two orthogonal translational stages. Even with micro-stages having very small displacements, they may be still too massive and too thick for the tool's spindle attachment with automatic tool changers.

When the misalignment is relatively small, for example, less than 100 μm, a kinematic/gimbal mount with a simple x-y adjustment may be used for correction. A kinematic/gimbal mount has axes of rotation (yaw, pitch) which intersect at the center front surface of the object being positioned. When the mount is adjusted, only the angle changes, not the distance. The dispensing tip is aligned to the rotational axis of the mill's spindle using four screws 750 as the kinematic mount's yaw-pitch adjustment motions. As seen in FIG. 7, the nozzle/printing assembly 720 is mounted to an electrical solenoid assembly (controlling the pneumatic pressure/vacuum) 730 next to the spindle axis 710 (Z-axis). In this manner, the position of the dispensing nozzle is accurately positioned with respect to the structure being formed, but the position of the nozzle with respect to existing structures is not altered.

5-Axis Alignment Using Secondary Stage System

Direct digital manufacturing uses a virtual design of an object to be manufactured. A new 3D design is typically made using standard CAD (Computer Aided Design) software. However, when the new design is part of an existing target object, creating the virtual design is more complicated. Extracting clean and accurate surface digital data is an important first step, requiring careful alignment of the target substrate and output point of the dispensing element, such as a nozzle or syringe tip, to the platform's coordinate system.

In 2D/2½ D spaces (e.g., printed circuit board manufacturing) the coordinate offset is used to align the target surface using an optical camera.

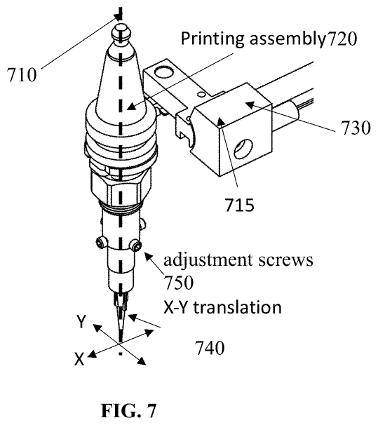

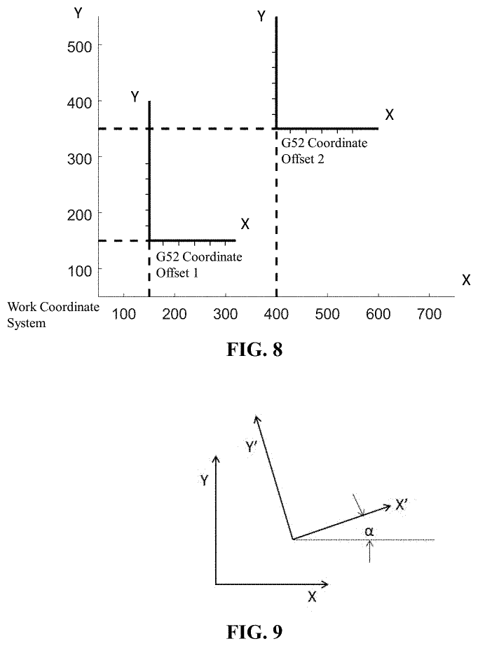

1. X-Y coordinate system offset: (e.g., solder dispensers such GPD, Essemtec dispensing systems) For solder paste dispensers, x-y coordinate system offset is widely used since rotational misalignment is rare in printed circuit board manufacturing. An example is shown in FIG. 8.

2. X-Y-Rot coordinate offset: (e.g., Optomec Aerosol Jet, AJ200, AJ300) For non-square substrates such as trapezoids, circles, or triangles, two alignment points are used, the first point as the origin and the second point to calculate a, a rotational coordinate offset, depicted in FIG. 9.

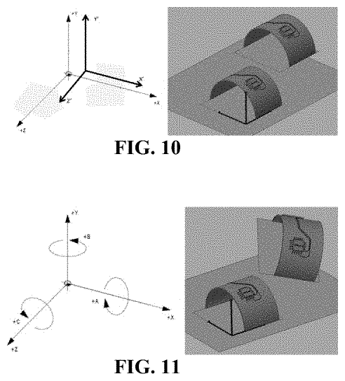

3. 3-axis coordinate offset: (3-Axis milling machine) For this, displacement in three orthogonal directions is determined as shown below in FIG. 10.

4. 5-Axis Coordinate Offset

Most CNC mills use X-Y-Z-A-B configuration (vertical mill) or X-Y-Z-A-C (horizontal mill) as seen in FIG. 11. Thus, the X-Y-Z offset is determined in each of three orthogonal directions and the rotational offset A-B or A-C is determined.

In this situation, creating an algorithm to align five axes of offset is a challenging task. Also, the operator needs to use special tools to measure all axis offsets.

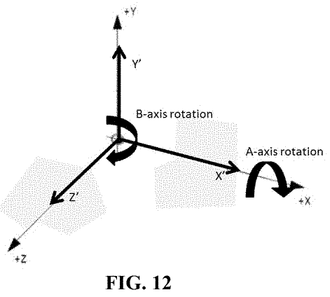

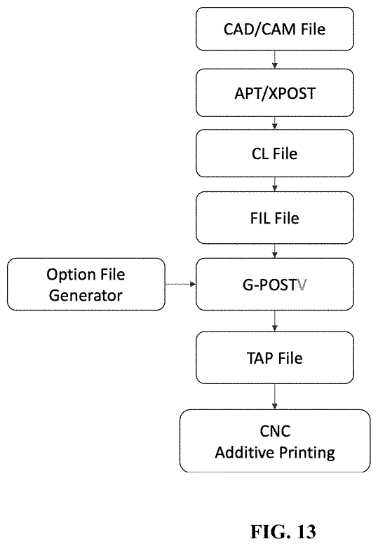

Therefore, the present invention uses a four-axis motion stage (FIG. 12) to align the dispensing surface structure. In the present invention, the B-axis is auto-aligned through the pallet system. The pallet system uses a reference plate to align a complex, three-dimensional structure. The A-axis alignment is automatic using a flat surface. Due to the B-axis auto-alignment through the pallet system, secondary alignment is performed using three translation stages and one rotation stage

Post-Processor Development for G-code Modification

As shown in Error! Reference source not found., CAD/CAM G-code is a control language for CNC machines to tell the machine tool to move to programmed locations (cutter location: CL). The post processor reads a CL file from CAD/CAM software and creates G-code based on factory interface language (FIL) and option file generator (OFG). In the present invention, we can add, delete, and modify G-code for the purpose of additive manufacturing using G-postprocessor. Peripheral relay switches allow the CNC system to have additive manufacturing capability. Through FIL programming, the present invention customizes the tool by inserting additional machine code (M-code) to control relay switches, which can be used to manipulate printing head valves, lasers, and so on. This G-postprocessor creates G-code, called a TAP file, which can be input into any industry standard CNC machine for additive manufacturing. An example of such code is presented in Appendix 1. Thus, pneumatic valve control is performed from inserted M-codes. Inter-process breaks are inserted for user commands or actions. Laser on-off times are controlled for laser machining and laser sintering. Pick-and-place valve systems may also be controlled. Finally, an automatic tool change (ATC) command in an inter-process may be made.

Optimization of Part Alignment

Inadequate alignment, imperfect CAD models and uneven shrinkage of substrate materials can lead to printed structure and printed electronics fabrication errors and concealment due to an inconsistent gap (distance) between a dispensing tip and a target curvature surface.

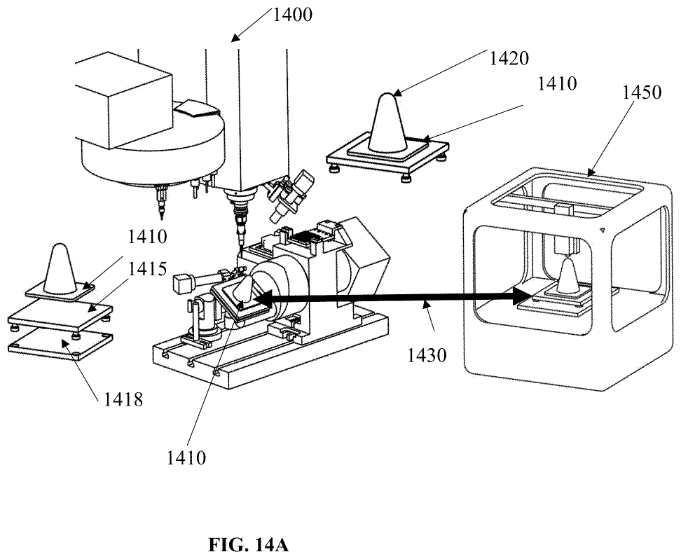

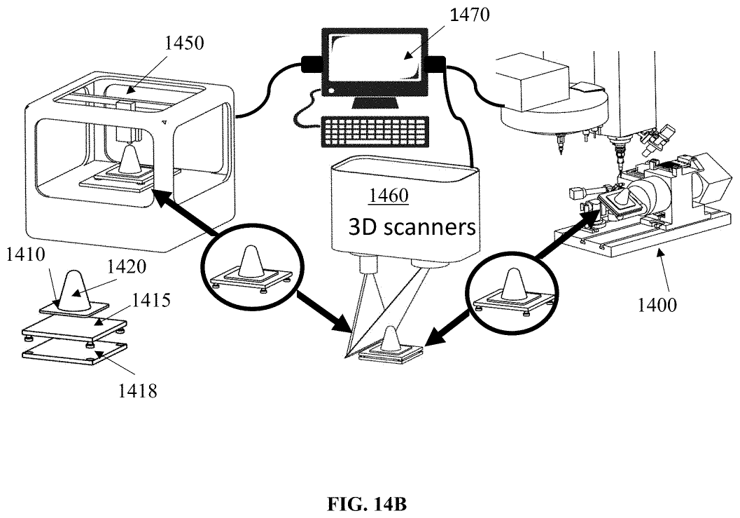

In some embodiments where other platforms are used besides the manufacturing platform of the present invention, a workpiece may travel to another platform on a removable fixture 1410 (FIGS. 14A, 14B,) with pre-established work coordinates (X-Y-Z-A-B axis) that eliminate the need to re-indicate or re-calibrate. The automated production process is comprehensive in that the pallet receiver is the only interface a new machine's worktable will ever require.

Fixture alignment is so precisely repeatable that parts can be removed from and returned to multiple platforms without losing references (FIG. 14A). Among the best ways to make a manufacturing process predictable, that is, to reduce the impact of natural, human-induced variation, is to implement robotics and pre-established work coordinates. In 3D space, every component and process is aligned to the CNC machine coordinate. Fixtures are used that provide a repeatable reference to within +/−10 micron, which is sufficient to shuttle fixtures from machine to machine without re-indicating the work at manufacturing platform.

The reference system for any CAM program is intact as soon as the part is mounted on a fixture. All virtual space is pre-programmed with reference coordinates, both machine and part reference coordinates.

As seen in FIG. 14A, a workpiece 1420 having a complex build shape is on a removable upper pallet plate 1410 that may be a portion of a pallet system including a pallet 1415 and base 1418. In the embodiment of FIG. 14, the workpiece is moved between the inventive manufacturing system 1400 and another material processing device such as 3D printer 1450. Because the workpiece moves on a removable plate 1410, alignment and references are not lost on moving to another platform.

Turning to FIG. 14B, the transport of the workpiece 1420 among various apparatus is depicted. In one aspect, the workpiece may undergo 3D scanning by scanner 1460 before or after printing by 3D printer 1450. In one aspect, the computer 1470 uses the scans to determine deposition parameters for 3D printer 1450 or deposition parameters for manufacturing system 1410. The pallet system retains all the alignment reference points moving from one platform to the next. Each system may include a bottom base plate 1418 for accepting pallet 1415 and removable plate/upper pallet plate 1410. The upper plate 1410 shuttles between the manufacturing system 1410, 3D scanner 1460, and 3D printer 1450.

Optimization of Manufacturing Tool Alignment:

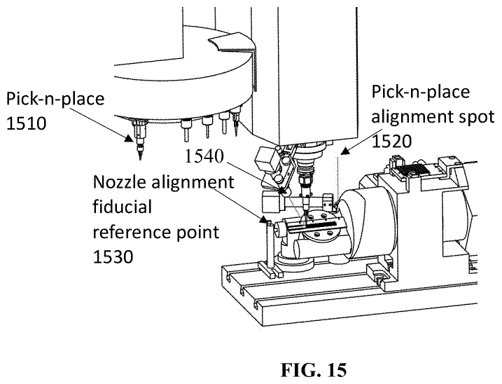

Alignment of 3D printer nozzles, dispenser tips, end mills/drills, laser beam, and vision systems (as seen in FIG. 15) to the 3D target topology is performed. With the selection of a CNC vertical mill (hardware) hybrid manufacturing system, capable CAD/CAM design tool (software) and the set of additive manufacturing tools (e.g., aerosol jet, printing nozzles), seamlessly integrating 3D physical and virtual manufacturing spaces together through proper alignment is important before manufacturing processes can start. As seen in FIG. 15, the manufacturing system includes a pick-and-place tool 1510 for positioning components on a substrate.

The present invention devises a fiducial point (mechanical or optical, preferably, optical) which provides the calibration reference for the manufacturing tools such as dispensers, mill bits, drill bits, optical CMM etc. An optical point is depicted at 1530 in FIG. 15 for a nozzle. A pick-and-place alignment spot 1520 is also depicted.

The present invention further formulates post-processor applications that include computer codes and the interface between a CNC mill and CAD/CAM software to automatically control pressure air/vacuum valves to provide electrical signals for relays and shutters for deposition of materials.

The present invention develops a nanometer scale real-time adjustment of the toolset Z-position with a feedback to achieve the sub-micron precision additive manufacturing (AM) capability. Further, to achieve micro-structuring capability, the integration of a laser displacement sensor (LDS) 1540 to the CNC vertical mill is used to extract the distance and position data.

For a standard CNC vertical mill, the precision subtractive machining starts with establishing a reference point of XYZ positions using a built-in touch sensor. X and Y reference coordinates are given by the movements of the platform and a Z-position reference coordinate will be recorded when the tool bit tip touches the built-in touch sensor. However, this mechanism of seeking the reference point does not work with additive manufacturing toolsets such as pneumatic dispensing tips or aerosol jet nozzles. Because a customized multi-function sample holder is added to a 5-axis platform in the present invention, further position offsets are added to the system. Therefore, a new mechanical reference point/fiducial is needed to convert a 5-axis mill platform to an additive manufacturing system, preferably an optical fiducial with calibrated vision system. The optical fiducial eliminates the requirement of touch sensing which, as stated above, cannot be used with various additive manufacturing material dispensers. The invention may also use a mechanical fiducial reference. A nozzle alignment fiducial reference point 1530 is depicted in FIG. 15.

Spindle Dual Vision System with a Concentric Rotational Feature

The ability to view the small features on the additive manufacturing surfaces and the ability to monitor dispensing tip distance is needed for quality fabrication. In conventional machine vision systems, two video cameras are required to orthogonally view area desired object, providing stereo vision. However, hybrid manufacturing platforms with an automatic tool changer (ATC) mechanism limit the space available for installing video camera attachments. The direction available for video camera attachments is opposite to the direction of the automatic tool changer, with a limited angular extension. Therefore, the vision system can only be installed around the opposite direction of the ATC which could provide a perspective view of the target area.

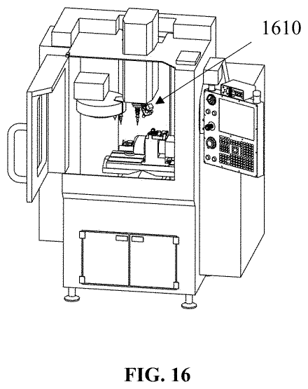

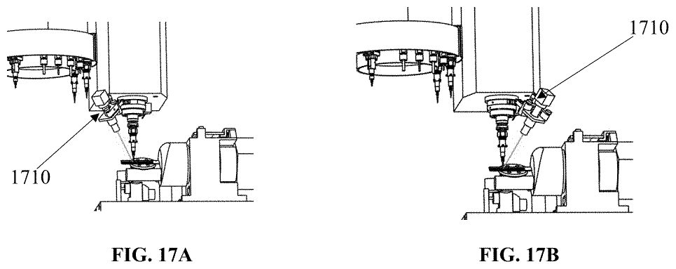

The present invention provides an alternative to a conventional system with two fixed orthogonal vision cameras. To avoid obstructing the automatic tool changer, this manufacturing platform of FIG. 16 provides a machine vision attachment 1610 to a non-rotational spindle house using a ball bearing to provide a mechanism to mount a pair of telocentric lenses and digital video cameras. The vision system mounted on a ball bearing has the mechanical integrity and rotational symmetry to achieve a perspective view of the target area. Further, the convenient rotation of the vision system on the spindle axis permits it to view the target area from many different directions as the fabrication process requires. Although a single camera is used, it can achieve a perspective view of the target area. FIGS. 17A and 17B depict the machine vision system 1710 being rotated about the spindle axis.

This system has several advantages:

1. The vision system views around the spindle axis

2. The vision system doesn't interfere with the spindle tool changer

3. Crash proof

4. Dual orthogonal system with yaw-pitch and translation motions built in for alignment and focus respectively

5. The vision camera rotates on the spindle housing to maintain same: of view as it rotates

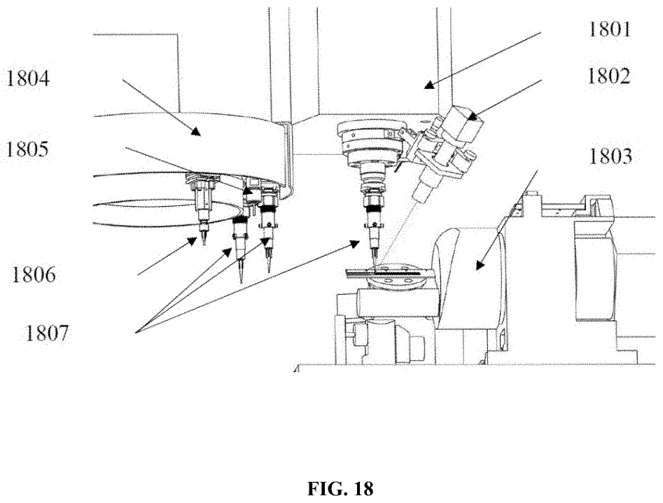

FIG. 18 depicts the relation of the machine vision system to other parts of the manufacturing platform. In FIG. 18, element 1801 represents the Z-axis, machine vision system 1802, trunion stage 1803, automatic tool changer 1804, endmill 1805, pick-and-place tool 1806, and dispensing/additive manufacturing tools 1807.

Metal Pastes for Additive Manufacturing

Using the above manufacturing platform, the present invention employs viscoelastic metallic pastes to print various three-dimensional objects such as metal cubes and domes with high aspect ratios. Although numerous silver and copper conducting metal pastes exist for electrical trace fabrication, metallic pastes based on other metals, e.g. steel, for structural applications are not commercially available. Using the inventive metal pastes, metallic structures with complex features (cavities and voids) can be fabricated by additive manufacturing with CAD/CAM toolpath optimization.

The inventive technique does not require high energy beam heating (laser or electron beam) or complex processing chambers/shielding gases and is easily scalable. The metallic structures of the present invention have been sintered at less than 300° C., more particularly at less than 250° C. The approach used in the present invention can also be applied to metallic pastes of a wide variety of metals including ferrous metals, cobalt, nickel-based alloys, or ceramics. The metal pastes of the present invention can be deposited in an open environment without the use of laser or electron beams. Further, complex features may be fabricated with internal cavities and intentional voids either for cooling or weight reduction.

The size dependence of the melting point of very small particles (the melting-point depression) has been studied since the 1960s. Molecular dynamics simulation has been performed to study the effects of particle size on melting temperatures of different metal nanoparticles. At nanoscales, metallic particles show thermo-physical properties distinct from those at microscales. The particle size in conductive nanoparticle pastes ranges from approximately 3 nanometers to less than 100 nm. Nanoparticles at the low-end size distribution may see significant melting temperature suppression. However, the particle size distribution for metallic powders used in commercial powder-bed metal additive systems is usually between 10-50 microns, according to the layer thickness. The melting temperature of these metallic particles is the same as its bulk melting temperature.

Nanoparticle silver pastes have been successfully used as die attach bonding materials in the microelectronic packaging industry to eliminate lead from electronic materials because of its hazardous effect on human health. Bonding using metal nanoparticles has the advantage of the nanoparticles fusing to become a metallic solid after a low temperature fusing process (sintering); the melting temperature of the sintered metallic solid approaches its bulk melting temperature.

Introducing nanoparticles into metallic additive manufacturing processes will drastically reduce the temperature requirement for sintering fabricated metallic parts to achieve structural strength. Implementing an FDM (fused deposition modelling)-equivalent metallic paste additive manufacturing process, which uses only the amount of material needed for the metallic structure, contrasts with laying down thin layer-by-layer metallic powders across an entire bed volume, with most powder unused, as in prior art powder bed systems. Thus, additive manufacturing processes using the inventive metal pastes of the present invention significantly reduce the usage of metallic powder.

Primary Metal Component

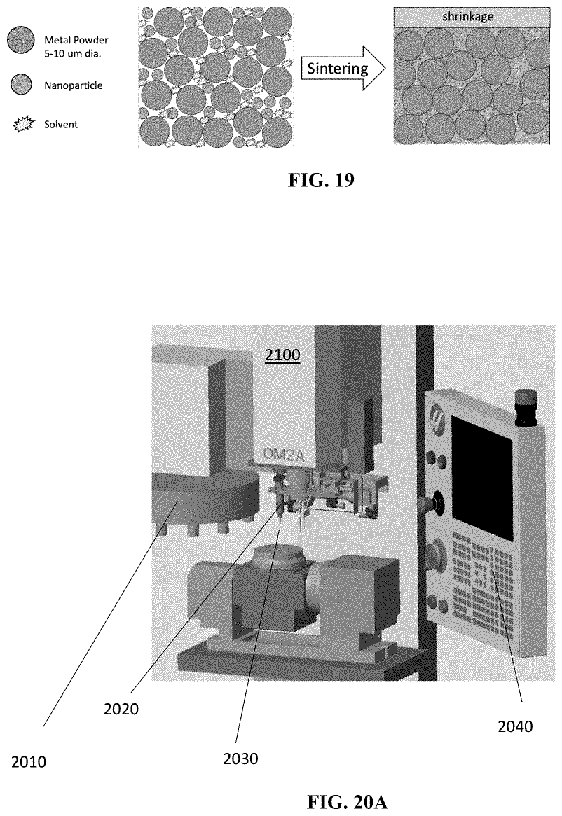

The present invention uses innovative metallic materials and processes to build metallic structures. As shown in FIG. 19, the metal pastes of the present invention include a first metal component of a first majority-phase phase structural metal comprising approximately 75 wt. % to approximately 90 wt. % of the total metal paste of first metal particles having particle sizes of approximately 1 micron to approximately 100 microns. A second metal component of a second binder-phase metal in the form of nanoparticles is included in the metal paste. The second binder-phase metal comprises approximately 3 wt. % to approximately 10 wt. % of the total metal paste weight. The second metal particles have a particle size of approximately 3 nanometers to approximately 100 nanometers. To make the paste flow and to hold the metal particles together, a binder having a weight percentage of approximately 2 wt. % to approximately 15 wt. % of the total metal paste weight is included. The binder may also be used to control the viscosity of the mixture, making the paste precision-controllable for various selected printing viscosities depending upon the object being deposited.

In one embodiment, gas atomization may be used to manufacture high quality metal powders as the first majority-phase phase structural metal in the metal pastes of the present invention. During the gas atomization process, a molten metal is atomized with inert gas jets into fine metal droplets which cool down during their fall in an atomizing tower. Metal powders obtained from gas-atomization offer an almost perfectly spherical shape combined with a high cleanliness level. The spherical metallic powder particles have excellent flow characteristics, achieving a high operating metallic paste viscosity for freestanding structure fabrication.

The size of particles produced by gas atomization may be controlled by varying process parameters such as: inert gas pressure, melt properties, nozzle design, and gas-to-metal ratio. Various post atomization processes including “scalping” to remove the oversize particles followed by either air classification or sieving are applied to obtain the required size fraction.

Particles having sizes between 1 to 10 microns, if detached, can become an airborne health and safety risk. In the present invention, metal paste preparation process occurs inside a reducing atmosphere hood and the resulting paste will not have detachable particles. Further, the metal powders used in the present invention may have a broader size distribution than those used in prior art powder bed processes, permitting the use of lower cost metal powders, typically of the same quality as those used in metal injection molding. The diverse particle size distribution results in a high packing density and enables high powder loading. This combination reduces the shrinkage of additive manufacturing fabricated parts during sintering and minimizes the nano-metal powder costs.

Nanoparticle Second Phase

A second metal component of a second binder-phase metal in the form of nanoparticles is included in the metal paste. The second binder-phase metal comprises approximately 3 wt. % to approximately 10 wt. % of the total metal paste weight. The second metal particles have a particle size of approximately 3 nanometers to approximately 100 nanometers. The use of nanoparticles in the metal pastes of the present invention drastically decreases the sintering temperature for establishing metallic alloying bonding between the nanoparticles and the larger metal powders. Nanoscale metal particles display a drastically reduced melting temperature compared to larger particle sizes or bulk metals. The reason for the melting point depression of nanoparticles may be understood by invoking the ratio of the number of surface atoms to the total number of atoms making up the particle. In bulk, this number is negligibly small. However, for nanoscale particles, the number of surface atoms is comparable to the total number of atoms. The bonding of atoms at the surface is much weaker, so the surface layer melts more easily than the bulk. The melting point of solids decreases initially slowly, then more rapidly as particle sizes decrease.

Binder

To make the paste flow and to hold the first and second metal particles together, a binder having a weight percentage of approximately 2 wt. % to approximately 15 wt. % of the total metal paste weight is included. The binder may also be used to control the viscosity of the mixture, making the paste precision-controllable for various selected printing viscosities depending upon the object being deposited.

Typical binders used may be organic solvents or polymeric binders depending upon the desired viscosity and other desired rheological properties. In one embodiment, a glycol ether is used as the binder such as diethylene glycol mono-n-butyl ether (C₈H₁₈O₃, DEGBE).

For deposition, the metal pastes of the present invention are typically loaded into a syringe barrel and then dispensed out of a nozzle. Because of this dispensing technique, the binder may be selected to give the overall metal paste the following properties: shear-thinning behavior to facilitate flow through fine nozzles without clogging, and viscoelastic behavior to enable printing of self-supporting structures. By using metallic powders of the first metal with particle sizes in the range of 1-100 microns, a non-Newtonian fluid paste may be formed with sufficient shear thinning and viscoelastic properties to be extruded through a nozzle to build a structure with a high aspect ratio. The composition and rheology of the metallic paste is adjusted to ensure reliable flow through a fine dispensing nozzle with an inner diameter that may be as small as 200 microns. The metal pastes of the present invention also promote bonding and adhesion between printed layers, to support the structural integrity during the drying and sintering processes.

Sintering: Following deposition, the printed metal structures are heated to fuse the particles as depicted in FIG. 19. Depending upon the selected second metal nanoparticles, the objects may be heated to a temperature of less than 300 C, more particularly, less than 250 C or less than 200 C. The sintering temperature depends on the nanoparticle size. The smaller the nanoparticle, the lower the sintering temperature due to melting temperature suppression related to nanoparticle size and the ratio of volume particles to surface particles. Therefore, the selected temperature will relate to the size of the second metal nanoparticles.

Metals

A large variety of metals may be deposited using the metal pastes of the present invention. In one aspect, the first metal may be aluminium, aluminum alloys, copper, copper alloys, cobalt, iron, iron alloys, steel, titanium, titanium alloys, or iron-nickel alloys; however, other metals may also be used. The nanoparticle second metal may also be selected from the above list of metals and may be the same as the first metal or different from the first metal. In addition to the above metals, the second metal may be silver or a silver alloy.

In one embodiment, maraging steel powders are used as the first metal in the metal pastes of the present invention. Maraging steel is class of low-carbon ultra-high-strength steels that have precipitates including alloying metals such as nickel, typically in a range from 15 to 25 weight percent, cobalt, molybdenum, and titanium. Maraging steel and good strength and toughness while also being malleable and machinable. In one embodiment, when maraging steel is selected for the first metal, silver, silver alloy, copper, or copper alloy is selected for the nanoparticle second metal.

Further Additives

Additional particles may be added to the metal pastes of the present invention to create custom mechanical properties in the deposited metal part. For example, ceramic particles such as silicon carbide and aluminum oxide may be added to create ceramic-in-metal matrices to improve the strength of the deposited metals. For this application, the ceramic particles may be added at a percentage of approximately 5-30 wt. %. Custom alloys may be created by selecting more than one type of first metal particle (e.g., iron and nickel first metal particles). Likewise, plural metals may be selected for the nanoparticle second-phase metal.

Additive Manufacturing with the Metal Pastes of the Present Invention

Additive manufacturing may be performed using the manufacturing platforms described above using printing tools such as syringe-based deposition heads. For example, commercial-based solder deposition machine tools may be used to deposit the metallic pastes of the present invention. Optionally, when manufacturing precision parts, the metallic pastes of the present invention may be deposited using an additive-manufacturing platform implemented, on a multiple axis tool, such as on a 5-axis machine tool, that includes syringe-based deposition heads.

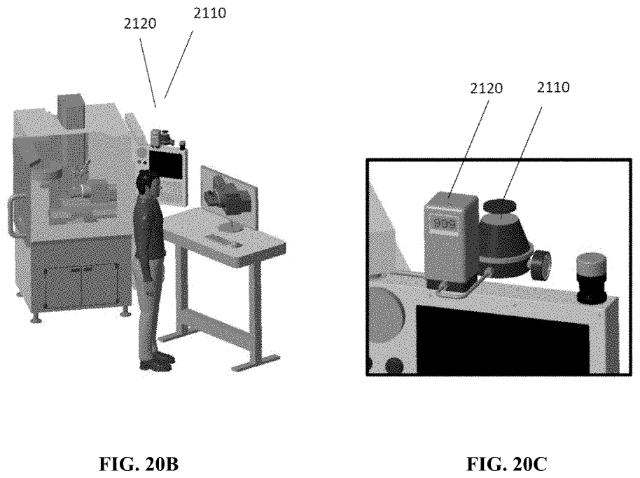

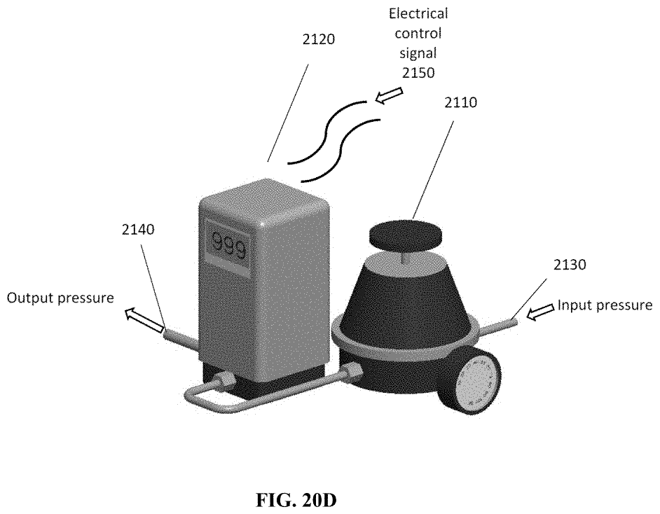

An exemplary deposition apparatus is depicted in FIG. 20A. FIG. 20A depicts a modified Haas compact mill CM-1 2100 with CAM control provided by the combination of PTC Creo CAD/CAM, an assembly to accommodate the syringe on the spindle, and post processor software to allow additive manufacturing on this subtractive manufacturing tool. This software has been used to design and generate toolpaths for the additive manufacturing processes; further control is provided by an interactive front control panel 2040. As shown in FIG. 20A, the apparatus integrates fused deposition modelling, inkjet printing, aerosol printing, laser ablation, laser curing, UV curing, pneumatic pressure-based printing heads 2020, and conventional machine tools (milling tools, drills, cutters, etc.) in a single 5-axis platform controlled by CAD/CAM techniques. These multiple functions in a single system allow maintaining a static reference coordination in additive manufacturing, resulting in better alignment while forming multilayer structures with multiple materials. A tool changer 2010 is positioned next to printing head 2020 and contains the various tools which may be positioned at the location of head 2020 when used in a fabrication process. Stage/substrate platform 2030 supports a workpiece (not shown).

FIGS. 20B, 20C, and 20D depict a modification of the system of FIG. 20A in which an additional pressure regulation system 2110, 2120 is depicted. Pressure regulation system 2110, 2120 may be used to custom regulate a dispensing nozzle pressure in coordination with movement of a workpiece on substrate platform 2030. This regulation of the dispensing nozzle will be discussed in further detail below.

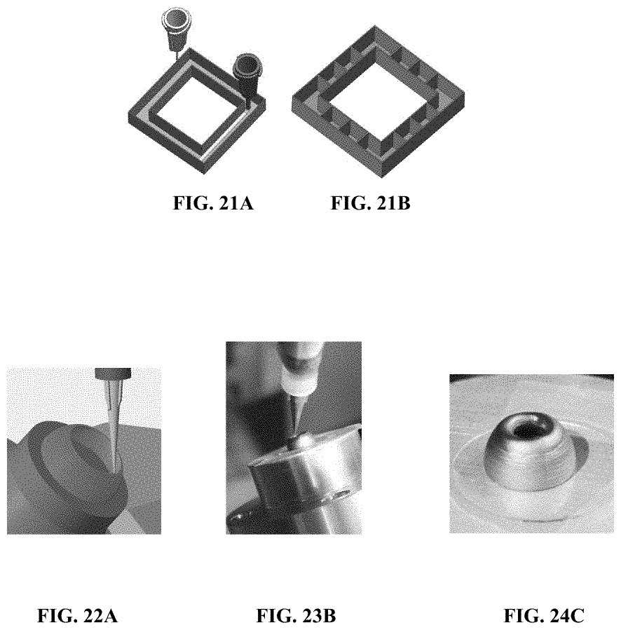

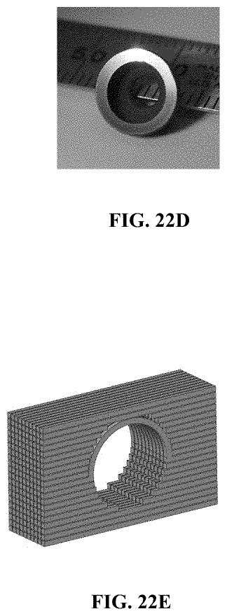

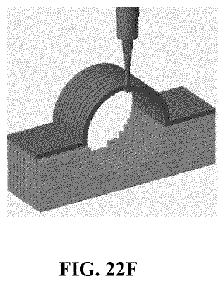

As discussed, the 5-axis system of FIG. 20A may be equipped with multiple heads; plural heads may be used to dispense the same metal paste but with different-sized nozzles to accommodate the requirements for different-sized parts and different-sized features on the same part. Depending upon the selected paste particle sizes and tailored paste viscosity, large inner diameter dispensing nozzles may be used to accelerate the metal paste dispensing and metallic structure build speed while still preserving surface quality. If the fabricated part has high surface finishing requirements, multiple dispensing heads with small nozzles may be used to build the inner and outer surfaces of the metallic structure before filling the space between the surfaces with metallic paste having a larger nozzle to complete the product. Such a technique is depicted in FIGS. 21A-21B. In FIG. 21A, a small nozzle builds the inner and outer walls of the hollow square part. As seen in FIG. 21B, ribs may be used to join the inner and outer surfaces. After creating the structure of FIG. 22B, a larger-sized nozzle may be used to rapidly fill the spaces between the ribs.

In addition to being rapid, there is another advantage to using a larger-sized nozzle. For a metal powder paste with a fixed particle size range, there is less chance for a large inner diameter nozzle to clog than for a small inner diameter nozzle. Empirically, smooth paste dispensing (no clogging) requires a particle size to be approximately 20 times smaller than the nozzle size. Thus, for an average particle size on the order of 10 microns, a nozzle size of 200 microns will typically remain unclogged. Such a size is typically sufficient as the small nozzle. Thus, for larger “fill” nozzles, the same particle size metal paste may be used with no clogging or a larger diameter metal paste may be used with the larger nozzle.

For the metal pastes with selected viscoelastic properties, the viscosity of the paste decreases as the syringe pressure increases or as the paste dispensing speed increases. The faster ejection speed metal paste leaving the nozzle leads to a lower viscosity of the metal paste inside the nozzle. Optimizing additive manufacturing processes to take advantage of this viscoelastic property leads to greater structure build speed while preserving surface quality.

The building procedure of FIGS. 21A-21B provides another capability: building finer cavities or intentional voids. Therefore, to reduce the weight of a part, some of the cavities created by the reinforcing ribs in FIG. 21B may be left unfilled.

Complex Build Geometries

With the inventive metal pastes various three-dimensional metallic structures may be fabricated. Exemplary shapes include cubes and domes. FIG. 22A depicts a toolpath for printing a dome. The dispensing nozzle tip is positioned to be tangent to the growing hemispherical surface. The combination of the toolpath generation preference and the small radius dome permits dome build angles up to 70°. FIG. 22B depicts a self-supported 9 mm radius metallic dome being fabricated using a metal paste of maraging steel powder and copper nanoparticles. FIG. 22C depicts an as-deposited metallic dome with an opening of 20° while FIG. 22D shows metallic finishing after sintering the as-deposited structure using a hot plate at 200° C. for 30 minutes. FIGS. 22E and 22F illustrate the toolpaths and building steps, generated by Creo CAD/CAM Manufacture, to build a metallic structure with a circular opening.

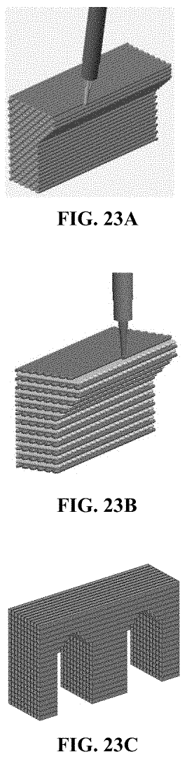

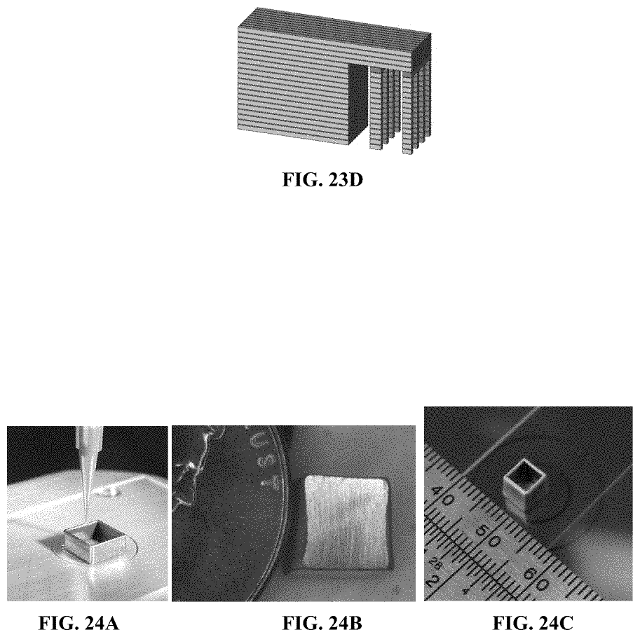

FIGS. FIG. 23A-23D illustrates toolpaths generated by Creo CAD/CAM Manufacture for building metallic structures with different size overhangs. FIG. 23A shows an angled layer-by-layer deposition process. FIG. 23B shows an angled layer-by-layer building process with alternative layers using orthogonal toolpaths. The toolpath design connects the already dispensed layers and reinforces structure's mechanical integrity. FIG. 23C illustrates the toolpaths for building a structure with double arches. For small metallic structure with overhangs, overhangs can be printed by rotating the already-printed structure 90 degrees to complete the overhangs. However, turning a large already-built metallic structure sideways before it is completely dried may not be an option since the structure is self-supporting, especially with high aspect ratio (wall). FIG. 23D illustrates the toolpaths for a structure with an extended overhang, plus sacrificial scaffolds. Using Creo CAD/CAM, complex structures can be designed and proper toolpaths will be generated to accommodate the metal paste additive manufacturing processes.

Uniform Dispensing

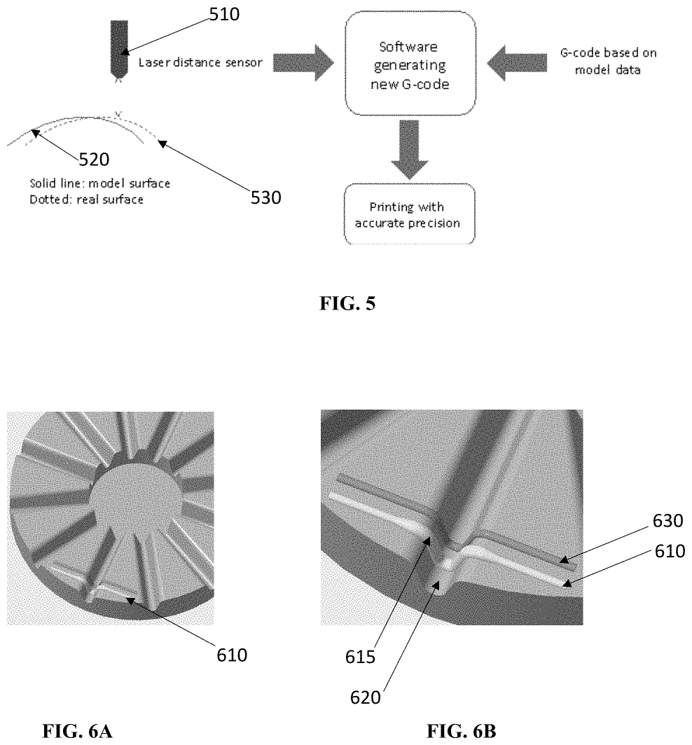

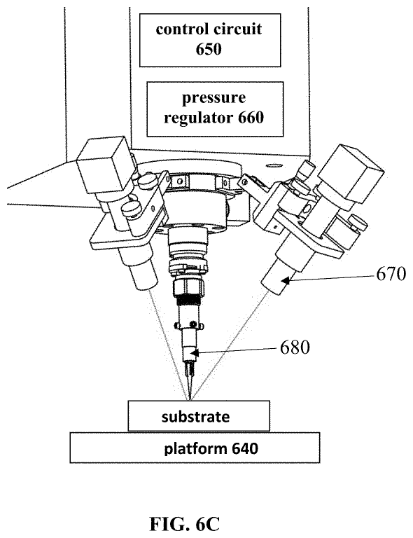

For additive manufacturing, the rate of material dispensed through pneumatic nozzles is dependent upon the material viscosity (typically temperature dependent), the inner diameter (ID) of the nozzle/needle and the applied pressure. For a 3D additive manufacturing system, the speed of the stage movement varies throughout the dispensing process, particularly for a 5-axis system with A and B axes. If the nozzle-dispensing parameters remain constant during the fabrication process, there will be excess material dispensed when the stage slows down. This excess dispensed material affects both the mechanical and the electrical properties of the product being formed, in addition to affecting the aesthetic appearance. As illustrated in FIG. 6A, the dispensed trace (white) has a significant dimension enlargement at the curved portion of the substrate when the linear dispensing speed of the CNC mill slows down with full 5-axis motion. FIG. 6B shows the close-up of the substrate curvature 620 and the dispensed traces. The trace 610 without automatic pressure adjustment has a sausage-shaped sections 615 and is clearly not uniform in dimension. Note that the material dispensed in this embodiment may be metals, polymers, ceramics, inks, or any other material capable of being dispensed by a syringe, nozzle, ink jet print head or other material deposition tool.

Previous efforts have focused on accommodating the pressure differential between the applied pressure and the true pressure at the exit of a material dispensing device, such as a syringe barrel. These efforts were aimed at achieving a uniform dispensing rate of the material versus time. However, this uniform dispensing rate is contrary to the requirements of 3D additive manufacturing. Because the stage speed varies significantly during the manufacturing process, the constant dispensing rate leads to excess material dispensed at sections where the speed of stage movement decreases due to change in direction and/or multiple axis movement. Therefore, the present invention controls the dispensing rate of material so that uniformly deposited conductive/dielectric traces or layers can be achieved, as the uniform dispensed trace 630 illustrated in FIG. 6B.

One way to implement the variable rate dispensing of material is adjusting the pressure applied to the barrel of the pneumatic nozzle proportional to the stage speed. As seen in FIG. 20D, an electrical control signal 2150 produces a proportional voltage to control a dynamic pressure regulator 2120. An exemplary commercially-available dynamic pressure regulator used in the present invention is the QPV1 from Equilibar which is an electronic high-resolution pressure control valve. The pressure regulator may include plural internal solenoid valves and a pressure transducer. The solenoid valves may act as inlet and outlets to provide a regulated outlet pressure in proportion to the input electrical control signal 2150. It is available in a wide range of calibrated pressure ranges covering vacuum through 150 psig (10 Bar). The QPV1 is available in either 0-10 VDC or 4-20 mA analog signal types, both of which may be used in the process of the present invention. An input pressure enters though port 2130 of constant-output pressure regulator 2110, is precisely regulated by dynamic pressure regulator 2120 and is output to outlet 2140 for actuating pneumatic nozzle 2020 of FIG. 20A.

A second way to implement the variable rate dispensing of material is using a vision system 670 (FIG. 6C) to monitor the dimension of the dispensed traces, both the width and the height. The information from the vision system is fed to the electronic feedback circuit 650 to generate a proportional voltage. The voltage controls the precision pressure valve 660, such as Equilibar's QPV1. The vision system includes a telecentric lens, which provides the same magnification at all distances, within a certain distance range, to monitor the dimensions of the dispensed traces with a calibrated CCD camera. Thus, the active pneumatic pressure tuning of the present invention provides uniform width and height of the deposited traces as seen by trace 630.

A feedback system depicted in FIG. 6C may also be used with the system in FIG. 20A. Pressure applied to the barrel of the pneumatic nozzle 680 is adjusted proportional to the stage/substrate platform 640 speed. An electric circuit 650 produces a proportional voltage to control a pressure regulator 660.

### Example 1: Maraging Steel Metal Paste

A metal powder of maraging steel powder from a gas atomizer, having 15 to 25 weight percent of nickel, with cobalt, molybdenum, titanium and iron as the balance is selected as the first metal powder. The particle size is on the order of 10 microns. The nanoparticles are selected to be silver nanoparticles having a size of approximately 20 nanometers. The silver nanoparticles are used in the form of a silver nanoparticle ink that includes diethylene glycol mono-n-butyl ether (C₈H₁₈O₃, DEGBE), a high boiling point solvent, that acts as a binder for the metal particles of the ink. The metal paste was prepared by gradually adding the maraging steel powder into the silver nanoparticle paste while it is being stirred/mixed with a stainless steel spatula inside a 10 mL glass beaker. Although the shape of the gas-atomized steel particles is relatively spherical, it still requires considerable care to blend the maraging metal powder with the viscous silver nanoparticle paste. After the silver nanoparticle paste is well-blended well with the initial quantity of maraging steel powder, more maraging steel powder is gradually added. Extra care is needed to ensure the uniformity of the metallic paste without any unmixed maraging steel powder, which can clog the small dispensing nozzle of 200 microns inner diameter. With an extended period of stirring, a metal paste is formed with approximately 85 maraging steel powder, 5% silver nanoparticle paste (with Ag concentration 91 wt. %) and 10% of binder. The maraging steel paste was used to build several self-supporting structures as depicted in the FIGS.

Although the additive manufacturing metal paste was prepared by mixing maraging steel power with pre-formed silver paste, it is understood that dry powders of both steel and silver may be mixed together followed by addition of various solvents. It is also understood that the viscosity of the paste may be controlled through control of the metal powder loading and solvent loading and that different viscosities may be selected depending upon the shape to be deposited. For example, shapes with a high aspect ratio may require pastes with a greater viscosity while for flatter designs a lower viscosity paste may be selected.

### Example 2

The maraging steel paste of Example 1 is dispensed using a 200-micron inner diameter tapered plastic nozzle. Different sizes of self-supporting boxes were built layer by layer with a high aspect ratio. FIG. 24A shows a 10 mm×10 mm×5 mm metallic box being fabricated. The wall thickness of this box is 0.65 mm. FIG. 24B shows the side wall finishing after sintering by placing this box over a hot plate at 200° C. for 30 minutes and then sanding.

FIG. 24C shows a picture of a 5 mm×5 mm×5 mm metallic cube fabricated using the inventive metal paste of Example 1. This free-standing metallic structure was air dried, a process that can be accelerated by circulating warm, dry air. After completely drying, this metallic cube can be sintered to its full mechanical strength by placing it on a hot plate at a temperature less than 200° C. for less than 60 minutes. This temperature is much lower than the bulk melting temperatures of the metallic paste ingredients.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated.

### APPENDIX 1: G-CODE EXAMPLE

This is a part of macro G-code embedded into existing a factory interface language (FIL) file to add machine code (M-code)

$$ ADD M52-M62 FOR Z-AXIS MOTION
_OUTPT=MACRO/

XWRD=POSTF(31,1,24) $$ GET VALUE FROM X
YWRD=POSTF(31,1,25)

ZWRD=P0STF(31,1,26)
DLX=POSTF(1,3,73)
DLY=POSTF(1,374)
DLZ=POSTF( 1,3,75)
DLA=POSTF( 1,3,76)
DLC=POSTF(1,3,78)...
...
...
IF ((XWRD .EQ. EMT).AND.(YWRD .EQ. EMT) . AND . (ZWRD .NE. EMT)$
...
DMY=FILEF(4,1,(TEXT/′M52′),1) $$ INSERT M52

DMY=FILEF(4, 1 ,(TEXT/G4P),1)

...
TERMAC
$$

1. A multiple-axis manufacturing platform for three-dimensional object fabrication operating in three dimensions and along at least two rotary axes, the platform comprising:
one or more additive manufacturing tools, each tool being attached to an assembly with an ISO-standard CNC taper;
one or more subtractive manufacturing tools;
a spindle including a spindle housing for engaging one of the additive manufacturing tools or the subtractive manufacturing tools;
an automatic tool changer holding the one or more additive manufacturing tools and the one or more subtractive manufacturing tools and for selecting among the additive manufacturing tools and the subtractive manufacturing tools and positioning a selected tool on the spindle;
a movable substrate platform for supporting a workpiece for additive or subtractive manufacturing by the selected tool;
a programmable control system having one or more programs for controlling the one or more additive manufacturing tools, the one or more subtractive manufacturing tools, the automatic tool changer and the movable substrate platform, wherein the program includes machine code to control one or more relay switches to control the additive manufacturing tools;
a machine vision system for detecting displacement between the selected tool and the workpiece or for detecting features of deposited material on the workpiece, the machine vision system comprising a single camera rotatable on the spindle housing to maintain a same field of view as it rotates about the spindle housing;
a laser displacement sensor to extract distance and position of the selected tool or the workpiece;
a feedback system cooperating with one or more of the movable substrate platform, the programmable control system, or the machine vision system to dynamically control material flow from an additive manufacturing tool.

2. The multiple-axis manufacturing platform according to claim 1, wherein the additive manufacturing tool is selected from a dispensing syringe, an inkjet printing head, or an aerosol printing head.

3. The multiple-axis manufacturing platform according to claim 1, wherein the feedback system includes a control circuit and a pneumatic valve and wherein the control circuit is configured to send a control signal to the pneumatic valve for creating a variable speed of material dispensing coordinated with the substrate platform movement and the workpiece geometry.

4. The multiple-axis manufacturing platform according to claim 1, further comprising a kinematic gimbal mount on the spindle for holding the additive manufacturing tool.

5. The multiple-axis manufacturing platform according to claim 1, further comprising a pallet system cooperating with the substrate platform for moving the workpiece.

6. The multiple-axis manufacturing platform according to claim 1, further comprising a pick-and-place tool for positioning components on a substrate.

7. The multiple-axis manufacturing platform according to claim 1, further comprising a trunnion.

8. The multiple-axis manufacturing platform according to claim 1, further comprising a laser-based machine tool.

9. The multiple-axis manufacturing platform according to claim 1, wherein at least a portion of the substrate platform is removable.

10. The multiple-axis manufacturing platform according to claim 1, wherein the one or more subtractive manufacturing tools includes an end mill, a laser drill, or a laser cutter.

11. A method for additive three-dimensional object fabrication using the multiple-axis manufacturing platform of claim 1, comprising:
positioning a replacement dispensing nozzle as a selected additive manufacturing tool with respect to the workpiece being formed without altering a nozzle position with respect to any existing structures.

12. A method for additive three-dimensional object fabrication using the multiple-axis manufacturing platform of claim 4, wherein the additive manufacturing tool is a dispensing syringe having a tip and wherein the tip is aligned to a rotational axis of the spindle using a yaw-pitch adjustment of the gimbal mount.

13. A method for additive three-dimensional object fabrication using the multiple-axis manufacturing platform of claim 1, wherein the laser displacement sensor measures an actual distance to a workpiece and the programmable control system generates a modified G-code based on the actual distance to the workpiece and wherein material deposition is based on the actual distance to the workpiece.

14. A method for additive three-dimensional object fabrication using the multiple-axis manufacturing platform of claim 1, wherein a metal object is formed from a metal paste, wherein the metal paste includes:
a first metal component of a first majority-phase structural metal, the first majority-phase structural metal comprising approximately 75 wt. % to approximately 90 wt. % first metal particles having a particle size of approximately 1 micron to approximately 100 microns;
a second metal component of a second binder-phase metal, the second binder-phase metal comprising approximately 3 wt. % to approximately 10 wt. % second metal particles having a particle size of approximately 3 nanometers to approximately 100 nanometers;
a binder having a weight percentage of approximately 2 wt. % to approximately 15 wt. % wherein the metal paste has a sintering temperature of less than approximately 300° C.

15. A method for additive three-dimensional object fabrication using the multiple-axis manufacturing platform of claim 1, wherein each of the one or more additive manufacturing tools and each of the one or more subtractive manufacturing tools is assigned a tool number, with an individual tool number and tool information stored in the programmable control system.

16. A method for additive three-dimensional object fabrication using the multiple-axis manufacturing platform of claim 1, comprising depositing a material with the additive manufacturing tool, and removing at least a portion of the deposited material with the subtractive manufacturing tool without workpiece realignment between the deposition and the removal.
